(19) United States
(12) Patent Application Publication
(10) Pub. No.: US 2022/0017982 A1
(43) Pub. Date: Jan. 20, 2022

(54) LOCALIZED RESISTANCE ANNEALING PROCESS

(71) Applicant: MAGNA INTERNATIONAL INC., Aurora (CA)

(72) Inventors: Pavlo PENNER, Woodbridge (CA); Xiaoping NIU, Richmond Hill (CA); Eric deNIJS, Toronto (CA)

(21) Appl. No.: 17/290,296

(22) PCT Filed: Nov. 4, 2019
(86) PCT No.: PCT/CA2019/051560

§ 371 Date: Apr. 30, 2021

Related U.S. Application Data
(60) Provisional application No. 62/755,637, filed on Nov. 5, 2018.

(51) Int. Cl. C21D 9/00; C21D 1/26; B21D 37/16; B21D 53/88; B21J 15/02

(52) U.S. Cl. CPC C21D 9/0068; C21D 1/26; B21J 15/02; B21D 53/88; B21D 37/16

(57) ABSTRACT

A localized annealing process and a part having localized areas with increased ductility produced by the process. The part is formed of hard material, tempered, and/or otherwise hardened such that it meets minimum hardness and ductility requirements. The part further includes localized areas that have increased ductility for workability, which could include various types of deformation. The localized annealing process includes providing a part with low levels of ductility and then annealing localized areas of the part for increased ductility that will need to be machined or attached to another formed part. The annealing process includes placing an electrode on either side of the localized area and generating electricity through the localized area. The material in the localized area is then heated from the electricity to form a more ductile physical structure.

### CROSS-REFERENCE TO RELATED APPLICATION

This PCT International Patent Application claims the benefit of and priority to U.S. Provisional Patent Application Ser. No. 62/755,637, filed on Nov. 5, 2018, titled “Localized Resistance Annealing Process,” the entire disclosure of which is hereby incorporated by reference.

### BACKGROUND OF THE INVENTION

### 1. Field of the Invention

The present invention relates to a process for annealing metal parts. More particularly, the present invention relates to a localized annealing process and a part having localized areas with increased ductility produced by same.

### 2. Related Art

This section provides background information related to the present disclosure which is not necessarily prior art.

Continuing efforts to reduce weight and increase fuel efficiency have driven the automotive industry to develop metal with improved strength and ductility allowing the use of thinner gauges while still maintaining industrial safety standards. During production, these metals often start as metal blanks that are later stamped in to automotive parts. Depending on an end use, automotive parts require different levels of strength and ductility. For example, a part stamped for use in an automobile may be subjected to several types of stress via rough driving surfaces, internal vibrations, and exposure to corrosive environments whereas a neighboring part may only be subjected to minimal stresses. Moreover, individual parts may be subjected to inconsistent stresses in localized areas. Because certain parts experience less hardship, they can be produced with lighter metals and metal alloys to satisfy specific strength or stiffness requirements. However, for those parts that are subjected the most stress, they are usually made of steel or steel alloy that is treated for optimized strength and ductility. These treatment methods typically involve heating the part to temperatures at which the physical and sometimes chemical property of the underlying metal is changed. Depending on the constituents of the metal alloy used, when a part is heated to a certain temperature, the constituents can form an uninterrupted microstructure before being cooled. While these treated parts can be made at thinner gauges to reduce weight, treated parts have become so hard that they are difficult to shape and connect to other neighboring parts. In addition, oftentimes it is beneficial to develop a part with a localized area that has increased ductility, for example, to improve absorption during an accident such that the driver and passengers experience a less abrupt change in speed and direction.

Attempts to produce parts with improved workability having localized areas with different levels of ductility and strength have resulted in the development of several processes in which localized areas of a part can be treated. One popular method involves heating a die between and/or during the stamping of metal parts. During this process, the die is heated to a temperature high enough to change the physical characteristics of the metal being stamped. While useful, heating the die is an expensive process and it is hard to accurately treat a small or complex-shaped localized area. More specifically, the localized areas that are heat treated have large transition zones that are neither completely treated or non-treated. Another method of localized treatment involves using a laser to heat localized areas, but again, this method is expensive and not particularly accurate. Yet another process involves the use of induction to heat localized areas, but this process is still in development and cannot treat small localized areas making it less than ideal for certain applications. Moreover, each of these methods are currently used for hardening localized areas and thus cannot be used to soften and improve workability.

Accordingly, there is a continuing desire to develop and further refine processes that are capable of treating a localized area of part to optimize strength and stiffness requirements while not detracting from the workability of the part.

### SUMMARY OF THE INVENTION

This section provides a general summary of the disclosure and is not to be interpreted as a complete and comprehensive listing of all of the objects, aspects, features and advantages associated with the present disclosure.

According to one aspect of the disclosure, a component for an automobile is provided. The component comprises a first part of metal material. The first part includes at least one localized area wherein the metal material in the localized area is annealed and includes a more ductile physical structure. The at least one localized area includes at least one deformation.

According to another aspect of the disclosure, a method of forming a component of an automobile including at least one tempered part is provided. The method comprises the steps of: forming a first part of a metal material; placing electrodes on opposite sides of the first part; energizing the electrodes and heating a localized area within the tempered part until the localized area has a physical structure with increased ductility; and forming at least one deformation within the localized area.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 illustrates a perspective view of a component constructed in accordance with the present disclosure;

FIG. 2 illustrates a perspective view of the component including a first tempered part attached to a second part;

FIGS. 3A and 3B illustrate localized areas within a part that have increased ductility and that include at least one deformation;

FIG. 4 illustrates a flow chart of certain aspects of the localized annealing process in accordance with one embodiment;

FIG. 5 graphically represents a distribution of hardness in localized areas of hot stamped steel;

FIG. 6A schematically illustrates localized resistance annealing process of the component with a spot welding machine in accordance with one embodiment of the disclosure;

FIG. 6B schematically illustrates localized resistance annealing process of the component with a resistance seam welding machine in accordance with another embodiment of the disclosure;

FIG. 7A illustrates method steps of the localized resistance annealing process; and

FIG. 7B illustrates steps of assembling a component out of a part that has undergone the localized resistance annealing process.

### DESCRIPTION OF THE ENABLING EMBODIMENT

Example embodiments will now be described more fully with reference to the accompanying drawings. In general, the subject embodiments are directed to a localized annealing process and a part having localized areas with increased ductility. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the views, the localized annealing process and resulting part provides an improvement to workability of selected localized areas within the part. The workability of the localized areas may include ease of deforming the localized area due to rigidity and hardness of the underlying material. As it will be appreciated with further reading, the localized annealing process results in a part comprising high strength low ductility material with select localized areas of increased ductility that are accurately and cheaply annealed into the part.

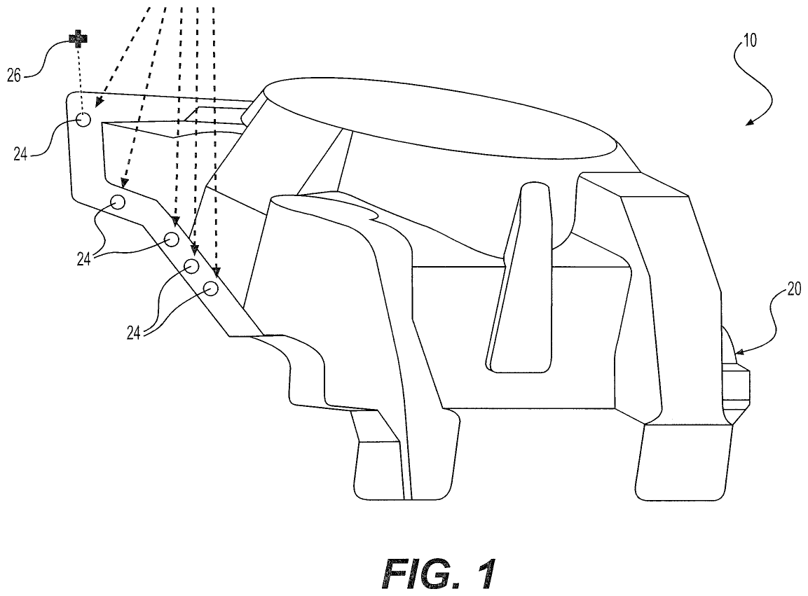

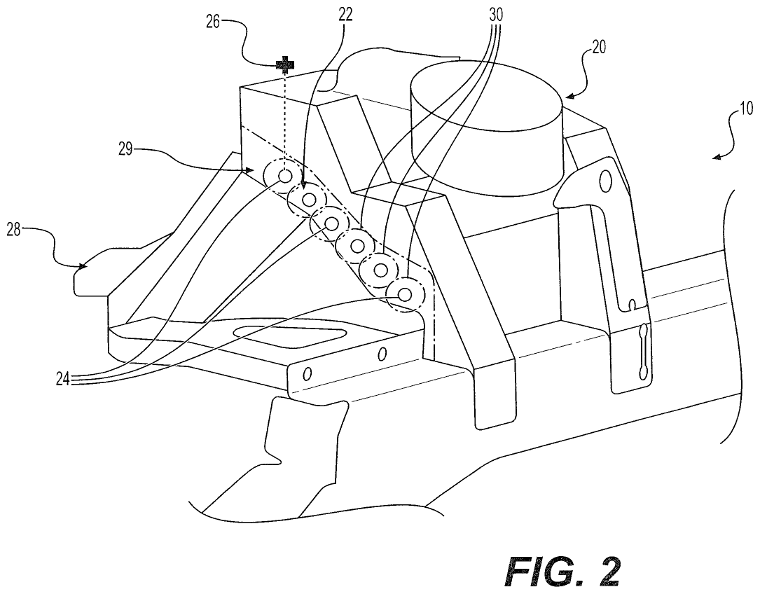

Looking first to FIG. 1, a component 10 including at least one part 20 is shown. In one example, the component 10 forms a portion of an automobile and the at least one part includes a part 20 formed from a metal material that is hardened. For example, the part 20 may be formed of an aluminum material that includes one of aluminum or aluminum alloy that has been hardened through a tempering process. For example, the tempered part 20 may have undergone a tempering process, such as one of an F-temper, a T4-temper, a T5-temper, or a T6-temper. For reference, parts designated “T7-temper” have undergone extensive heat treatment and are artificially aged. More specifically, the T7-tempered parts may be solutionized at 465° C., air quenched, and artificially aged from 215° C. to over 225° C. from a “T4-temper” condition. Parts which have undergone a T7-temper process can be more easily riveted whereas parts designated F-temper and T4-temper through T6-temper are too hard. The designation “T5-temper” refers to a part that has undergone artificial aging at 215° C. as casted. The T5-temper process is a stabilization treatment that prevents changes in mechanical properties of the material during the life of the part. The designation “T6-temper” is for parts that have been heat treated with forced air quenching and artificially aged. The designation “F-temper” is for parts formed from casting materials presented from a foundry as casted that have not undergone heat treatment. Because the example part in FIGS. 1 and 2 has undergone one of the above referenced tempering processes resulting in reduced ductility, the tempered part 20 is difficult to work with, e.g., deform. Accordingly, at least one localized area 24 has been annealed to increase ductility and facilitate workability. In one example, the tempered part 20 presented in FIGS. 1 and 2, has undergone one of F-temper, T4-temper, T5-temper, and T6-temper. It should be appreciated, however, that the part does not need to have undergone a hardening process such as the previous tempering processes for the annealing step to be useful. For example, the part 20 may be formed a high strength metal or metal alloy, such as steel material including one of steel or steel alloy with carbon, that has not been tempered and is difficult to work with regardless. Likewise, the part 20 may have undergone different types of hardening processes not previously detailed such as various forms of heat treatment and cold working. In instances with steel or steel alloy, the material may have initially been treated to include additional austenite or martensite concentrations.

As shown in FIGS. 1 and 2, the part 20 includes at least one localized area 24. The at least one localized area 24 includes a plurality of sequentially spaced localized areas 24 being small and circular shaped, wherein a mechanical fastener 26 is driven through each of the annealed localized areas 24. The mechanical fasteners 26 may be rivets and the rivets may be self-piercing rivets. As shown in FIG. 2, the example component 10 includes at least one part 20 that has undergone a hardening process and more particularly a tempering process. As such, the at least one part 20 includes a first tempered part 20 from of aluminum material and a second part 28. The first tempered part 20 includes a first overlap region 22 and the second part 28 includes a second overlap region 29. The second part 28 is connected to the first tempered part 20 by adjoining the overlap regions 22, 29 and driving at least one fastener 26 therethrough. In one example, the second part 28 requires less strength and rigidity and thus does has not comprise hard material nor has it undergone a hardening process. However, in the illustrated example, the second part 28 is also formed of aluminum material that has undergone a similar tempering process that makes workability difficult, for example, one of an F-temper, T4-temper, T5-temper, and T6-temper process. As such, the second part 28 includes at least one second localized area 30 that has been annealed in a location that is adjacent to the at least one localized area 24 of the first part 20 when the first and second overlap regions 22, 29 are adjoined. In the illustrated example, the at least one second localized area includes a series of corresponding second annealed localized areas 30 superimposed over the first annealed localized areas 24. Like the first annealed localized areas 24, the second annealed localized areas 30 have been annealed to increase ductility. A series of rivets 26 (e.g., self-piercing rivets) extend through overlap regions of both parts 20, 28, wherein each rivet 26 extends through a first annealed localized area 24 and a second annealed localized area 30. In addition or in the alternative to the rivets 26, other types of fastening methods may be used. For example, adhesives, welding, and other screw/rivet-type mechanical fasteners could be utilized which have traditionally been prevented as a result of the hardness and low ductility of the underlying material.

While not limited thereto, the first part 20 may comprise any one of aluminum, aluminum alloy, steel or steel alloy with carbon. In applications where the first part 20 and/or the second part 28 will experience large amounts of stresses, it is preferable that the second part 28 also consists of aluminum, aluminum alloy, steel or steel alloy with carbon. If the second part 28 is aluminum or aluminum alloy it can also be tempered as described above for modifications of hardness and ductility, for example, one of F-temper, T4-temper, T5-temper, and T6-temper. If either part is steel or steel alloy, it may undergo hardening processes as described above.

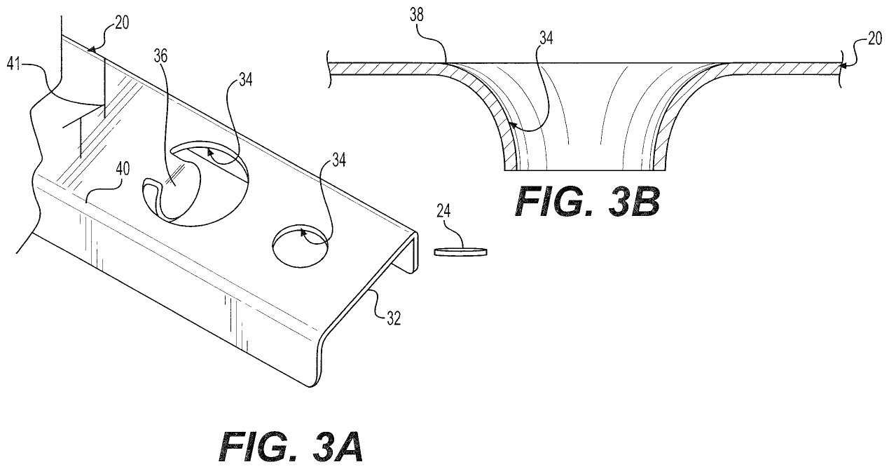

Referring now to FIGS. 3A and 3B, a part 20 having undergone a hardening process in accordance with a second embodiment is shown. The part 20 may be formed of tempered aluminum or aluminum material. More specifically, the tempered part 20 has undergone a tempering process, for example, one of F-temper, T4-temper, T5-temper, and T6-temper. The tempered part 20 includes at least one localized area 24 that has been annealed such that it has increased ductility. As shown, the localized area of the tempered part 20 includes a cut 32 or a boarder that has been trimmed along the width or length of the tempered part 20. The tempered part 20 could also include localized areas 24 sized for receiving various apertures 34, which could include flanges 36 or piercings 38. The flanges 36 and remaining material that has been pierced may have been previously annealed. Furthermore, the localized area could also include a bend 40. A localized area 24 is illustrated as being completely removed from the part 20. In addition, depending on the location of the tempered part 20, it may also be beneficial to include a localized area that includes a planned absorption zone 41 with increased ductility in order to control and improve energy absorption during an accident.

As previously described, the part 20 preferably comprises one of aluminum, aluminum alloy, steel or steel alloy with carbon. If the part 20 comprises steel alloy with carbon, it may include steel alloy that is grade 22MnB5 which comprises, in weight percent (wt. %) based on the total weight of the alloy: Carbon (minimum 0.19 wt. %, maximum 0.25 wt. %); Silicon (maximum 0.40 wt. %); Manganese (minimum 1.10 wt. %, maximum 1.40 wt. %); Boron (minimum 0.0008 wt. %, maximum 0.005 wt. %); and the remaining balance being Iron. The hardening process may include, for example, one of heat treatment and cold working.

If the part 20 comprises aluminum or aluminum alloy it may include an aluminum alloy that comprises, in weight percent (wt. %) based on the total weight of the alloy: Iron (no minimum, maximum 0.20 wt. %); Silicon (no minimum, maximum 10.50 wt. %); Manganese (no minimum, maximum 0.50 wt. %); and the remaining balance being Aluminum an impurities. The hardening process may include, for example, one of the afore described tempering processes.

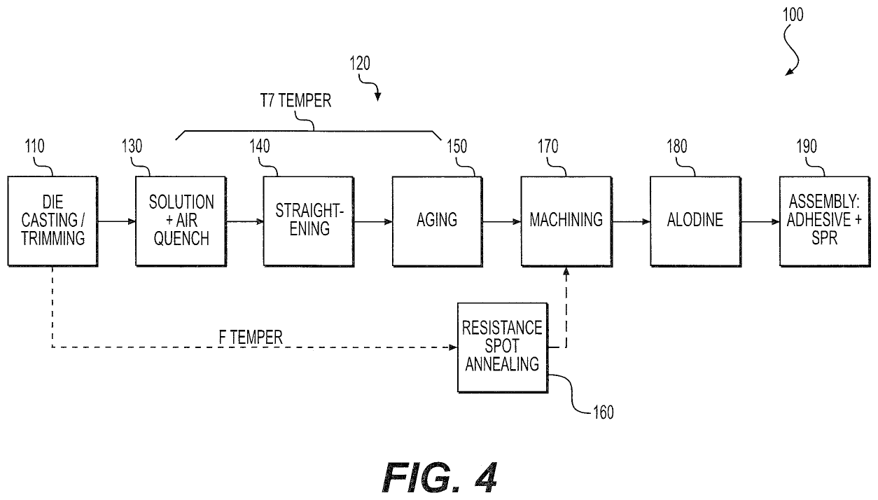

Looking to FIG. 4, a flow chart of certain aspects of the localized annealing process 100 with a metal part casted of aluminum or aluminum alloy is presented. The process 100 begins by die casting 110 the material into a shape. Conventionally, when aluminum or aluminum alloys are used, the casting is tempered 120 to T7 to improve workability. The T7-temper process many include solutionizing and air quenching 130, straightening the casting 140, and artificially aging 150 the casting. However, in accordance with the present invention these conventional steps 130, 140, and 150 are no longer required. Instead of these conventional steps, the casting remains in F-temper designation and receives resistance spot annealing 160 in a preselected localized area to increase ductility. The localized area is then machined 170, which may include a step of forming a deformation within the localized area. The step of forming a deformation may include forming at least one of a cut, a bend, an aperture, a trimmed edge, an absorption zone, a piercing, or a flange. Once machined, the casting receives an alodine treatment 180 followed by assembly 190 into a larger component, which could include connecting to a second part via adhesives and self-piercing rivets. Instead of casting, it should be appreciated that the metal blank may also be formed in step 110 by other methods and of other materials, e.g., stamping a blank formed a steel material.

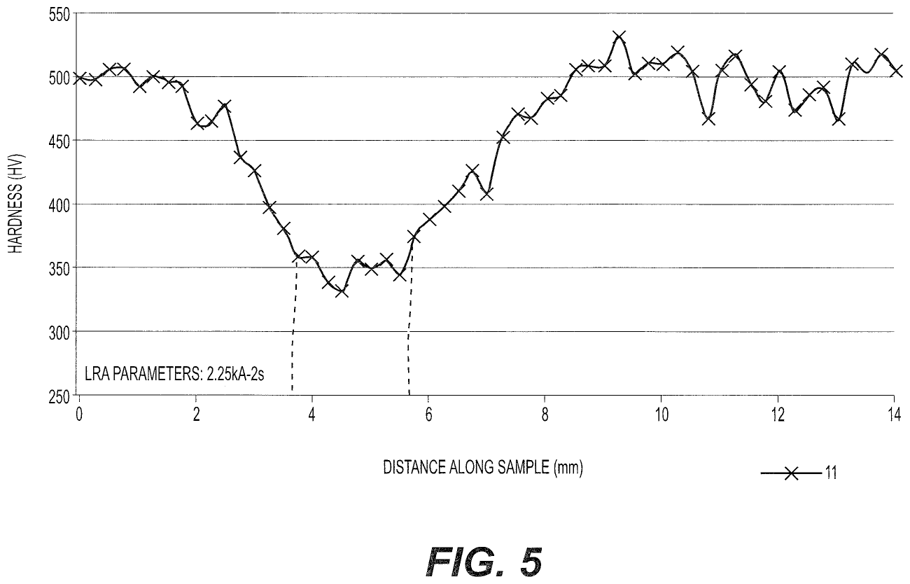

FIG. 5 graphically represents a distribution of hardness in localized areas of a part of hot stamped steel according to an example embodiment. The localized area is shown between 3.8 and 5.8 mm on the X-axis. It will be appreciated that the localized area that has undergone the annealing process 160 has increased ductility and is thus softer and includes improved workability. The hardness of the part 20 is shown in Vickers Pyramid Number (HV). The softened localized areas have a reduced HV, more particularly in this example embodiment, the part 20 is made of hardened steel and has an average hardness of 500 HV whereas the localized area has an average hardness of 350 HV. Similarly, parts 20 comprising aluminum or aluminum alloy have a hardness ranging from 90 to 120 HV and the localized areas have a hardness ranging from 70 to 85 HV. Additionally, parts 20 comprising other types of steel material have a hardness ranging from 400 to 550 HV and the localized areas have a hardness ranging from 250 to 350 HV. It should be appreciated that regions surrounding the localized area exhibit a minimized decrease in hardness demonstrating the accuracy of the annealing process.

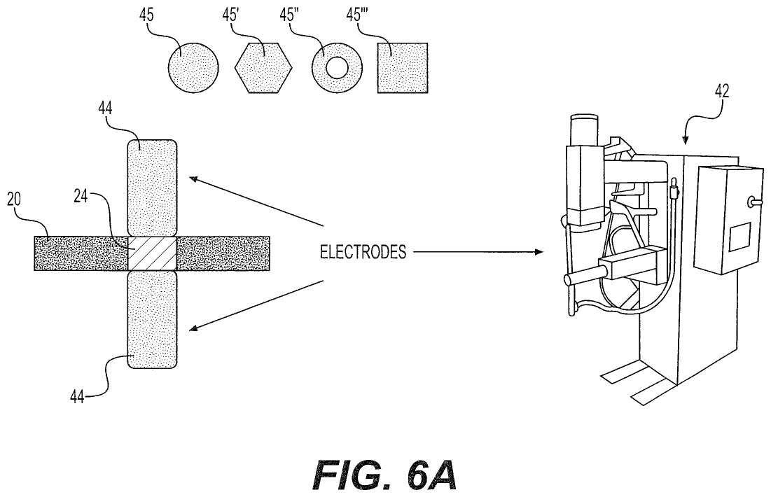

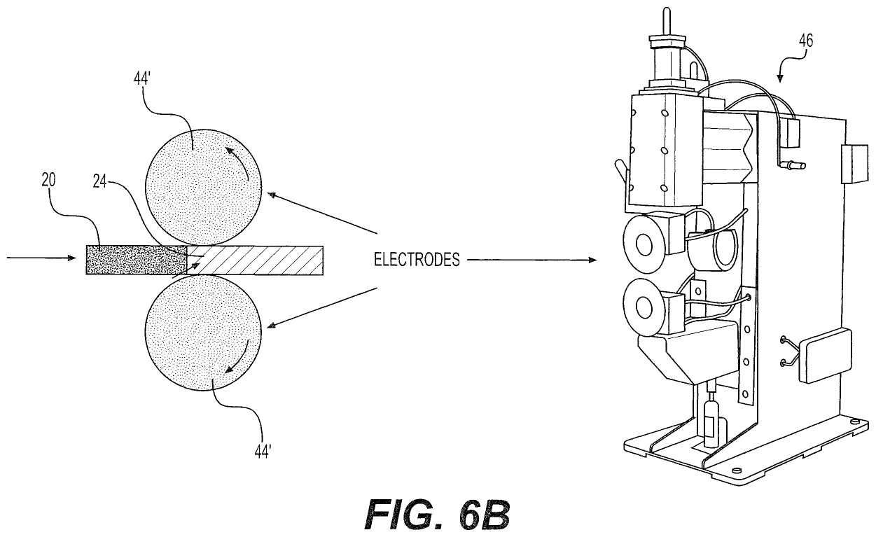

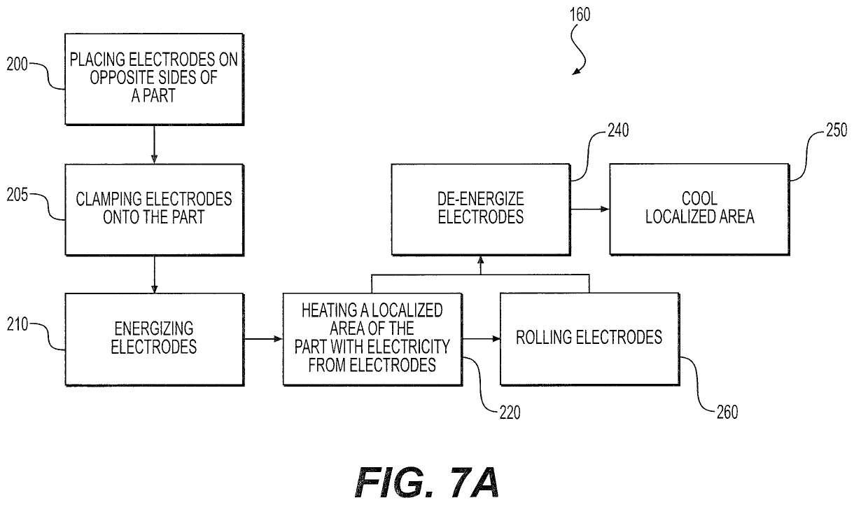

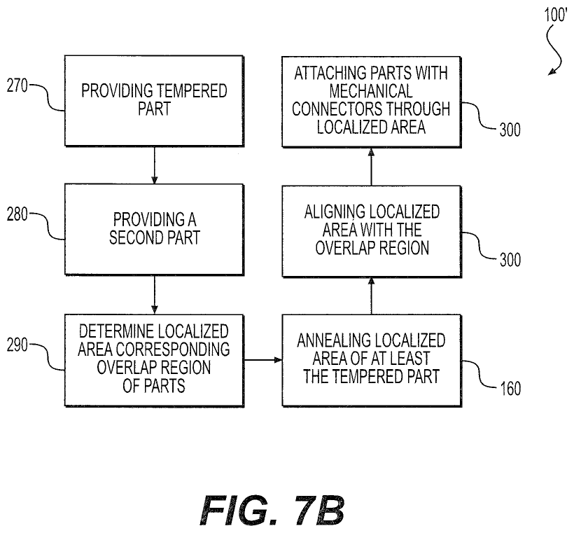

FIGS. 6A and 6B, and 7A provide further details about the annealing step 160 discussed in FIG. 4. Referring initially to FIG. 6A, a spot welding machine 42 is shown annealing the part 20. The spot welding machine 42 includes a pair of diametrically opposed electrodes 44 made of copper. These electrodes 44 can include any number of cross-sectional shapes 45, 45′, 45″, 45′″ and sizes depending on the types of processes to be carried out on the localized area 24. For example, a circular cross-sectional shape may be provided that includes a radius which is slightly larger, slightly smaller, or the same size as the shank of a mechanical fastener that will be driven therethrough.

As shown in FIG. 7A, a detailed flow chart of the annealing step 160 is presented. The annealing step 160 includes placing 200 electrodes in contact with opposite sides of the localized area of the part. Next, the electrodes are clamped 205 together, exerting mechanical pressure on opposite sides of the localized area. After clamping 205, for example for over 200 milliseconds, at least one of the electrodes is energized 210 with an electrical current. Because copper is a good conductor of electricity, the tendency of the current is to jump between the electrodes on opposite sides of the part. However, the transfer between electrodes is interrupted by the resistance of the part, which causes the localized area to heat 220 via friction of the electrical current passing therethrough. This heating 220 step could potentially exceed temperatures of 2000° F. or more. The current is then turned off 240 and the electrodes may then be held in place long enough for the localized area to cool. The cooling 250 leads to the formation of a more ductile microstructure, the cooling step may include allowing the part to sit for at least 200 milliseconds and/or applying a cooling medium thereto. As illustrated in FIG. 5, localized areas, which have undergone these steps, exhibit a decline in Vickers Hardness and are softer and easier to work with. Moreover, these localized areas are extremely accurately defined with small transition zones.

Referring now to FIG. 6B an alternative machine that is similar to the sport welding machine 42 in FIG. 6A is provided. More particularly, the spot welding machine 42 is replaced with a seam welding machine 46 having a pair of electrode disks 44′. The annealing process 160 in FIG. 7A may thus further include rolling 260 the electrodes during the steps of clamping 205, heating 220, and energizing 210 in order to soften a localized area that is elongated. Thus, even after cooling 250 this area remains in a softened state such that it is easier to work with, i.e., machine via deformation. Using electrode disks 44′ may be preferable in applications that include forming a localized area that is elongated and is to be trimmed or bent. It should also be appreciated that the machining process 170 could occur before the localized area has been cooled 250.

FIG. 7B is a flow chart illustrating a method 100′ in accordance with another aspect of the disclosure. The method 100′ provides steps for forming a component with a first tempered part and a second part that may or may not be tempered. The method 100′ begins by providing 270 a tempered part (which may include providing a first part and undergoing one of an F-temper, T4-temper, T5-temper, and T6-temper processes to temper the first part). The method 100′ continues by providing 280 a second part (which may include providing a second part and undergoing one of an F-temper, T4-temper, T5-temper, and T6-temper processes to temper the second part). Next, localized areas of at least the first tempered part (and the second part if it is tempered) are determined 290 based on which regions of each part overlap during attachment. Depending on how these parts are attached to one another, the localized areas are then annealed 160. Step 160 may include annealing several localized areas that are sequentially spaced. Localized areas of both parts are then aligned 300 and attached 310 by driving a fastener, rivet, or other connector through localized areas (e.g., each of the sequentially spaced localized areas) of each part. In the alternative, these parts can be annealed 160 together such that the step of aligning 300 can be completed before the step of annealing 160. It should also be appreciated that the second part may already have higher ductility such that it does not need to be annealed 160.

In this case, the first tempered part is the only part which is annealed 160 before alignment 300 and attachment 310.

Several parts and process steps throughout the disclosure have been described as tempered or undergoing tempering processes with aluminum, however, instead of having a part that is tempered, the above processes, components, and parts can include a high strength, low ductility metal material that has not undergone any hardening process or has undergone a hardening process different than tempering. For example, either of the afore described first and/or second parts may comprise steel or steel allow that has not undergone a hardening process or has undergone a hardening process. Generally, at least one of the parts comprise either a hard material that is difficult to work with or softer material that has undergone a hardening process that makes it difficult to work with.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A component for an automobile comprising:
a first part of metal material;
the first part including at least one localized area wherein the metal material in the localized area is annealed and includes a more ductile physical structure; and
the at least one localized area including at least one deformation.

2. The component according to claim 1, wherein the deformation includes at least one aperture, and wherein a mechanical fastener extends through the aperture.

3. The component according to claim 2, further including a second part connected to the first part with the mechanical fastener extending through the at least one aperture.

4. The component according to claim 3, wherein the second part further comprises a second localized area that is annealed and includes a more ductile physical structure, and wherein the second localized area includes at least one second aperture that the mechanical fastener also extends through.

5. The component according to claim 4, wherein the mechanical fastener includes a self-piercing rivet.

6. The component according to claim 4, wherein the first part is formed of aluminum material and includes one of F-temper, T4-temper, T5-temper, and T6-temper designation.

7. The component according to claim 4, wherein the first part is formed of a steel material.

8. The component according to claim 7, wherein the steel material includes one of steel or steel alloy with carbon that has undergone a hardening process.

9. A method of forming a component of an automobile including at least one part comprising the steps of:
forming a first part of a metal material that has undergone a hardening process;
placing electrodes on opposite sides of the first part;
energizing the electrodes and heating a localized area within the first part until the localized area has a physical structure with increased ductility; and
forming at least one deformation within the localized area.

10. The method according to claim 9, further including rolling the electrodes across the localized area and the step of forming a deformation includes one of cutting, trimming, or forming a bend.

11. The method according to claim 9, further including providing a second part and overlapping at least a portion of the second part with the localized area.

12. The method according to claim 11, wherein the step of forming a deformation within the localized area includes forming an aperture and driving a mechanical fastener therethrough and into the second part.

13. The method according to claim 12, wherein the second part is formed of a metal material that has also undergone a hardening process.

14. The method according to claim 9, wherein the first part is formed of aluminum material and the hardening process includes tempering to one of F-temper, T4-temper, T5-temper, or T6-temper designation.

15. The method according to claim 9, wherein the first part is formed of a steel material and the hardening process includes at least one of heat treatment and cold working.

16. The method according to claim 9, further including:
providing a second part;
placing electrodes on opposite sides of the second part; and
energizing the electrodes and heating a second localized area within the second part until the second localized area has a physical structure with increased ductility.

17. The method according to claim 16, further including overlapping the first localized area with the second localized area and forming at least one deformation within the second localized area.

18. The method according to claim 17, wherein the step of forming at least one deformation within the first localized area and the step of forming at least one deformation within the second localized area includes driving a rivet through the first localized area and the second localize area.

19. The method according to claim 9, further including forming an overlap region on the first part by energizing the electrodes and heating additional localized areas within the first part until the overlap region is formed of a series of spaced localized areas having a physical structure with increased ductility

20. A method of forming a component of an automobile including at least one part comprising the steps of:
forming a first part of a metal material;
increasing one of a martensite concentration or an austenite concentration in the first part;
placing electrodes on opposite sides of the first part;
energizing the electrodes and heating a localized area within the first part until the localized area has a physical structure with increased ductility; and
forming at least one deformation within the localized area.
